(19) United States
(12) Patent Application Publication
(10) Pub. No.: US 2005/0253504 A1
(43) Pub. Date: Nov. 17, 2005

(54) Protector of an organic light-emitting device and manufacturing method thereof

(76) Inventor: Chih-Hung Su, Hsinchu City (TW)

Correspondence Address: RABIN & Berdo, PC, 1101 14TH STREET, NW, SUITE 500, WASHINGTON, DC, 20005, US

(21) Appl. No.: 11/006,630

(22) Filed: Dec. 8, 2004

(30) Foreign Application Priority Data
May 13, 2004 (TW) 93113528

(51) Int. Cl. H01J 1/62; H01J 63/04

(52) U.S. Cl. 313/504

(57) ABSTRACT

An organic light-emitting device with a first protecting layer is disclosed. The organic light-emitting device includes a substrate, a transparent electrode formed on the soubstrate, an organic emissive structure formed on the transparent electrode, a metal electrode formed on the organic emissive structure, and a first protecting layer, formed on the metal electrode. The first protecting layer comprises an inert metal.

This application claims the benefit of Taiwan application Serial No. 93113528, filed May 13, 2004, the subject matter of which is incorporated herein by reference.

### BACKGROUND OF THE INVENTION

1. Field of the Invention

The invention relates in general to an electroluminescent apparatus, and more particularly to an organic light-emitting device.

2. Description of the Related Art

Organic electroluminescent devices, such as organic light emitting diodes (OLEDs), have been popularly applied to various flat displays because such advantages of self-emissive, very thin form factor, high luminance, high luminous efficiency, high contrast, fast response time, wide viewing angle, low power consumption, wide temperature operation range, and potential of flexible substrate.

The emissive theory of OLED is with the injection of electrons and holes from metal cathode and transparent anode respectively, after recombining within organic film the energy is then transferred into visible light. However, since the metal cathode and the organic film easily react on water, the metal cathode is oxidized and separated from the organic film if the metal cathode contacts with water moisture so that dark spots exist on the screen of the display. The area of the dark spots broadens and the numbers of the dark spots increase for a period of time. Therefore, luminance of the OLED is decreased and the display quality is affected, further the life time of the OLED is shortened.

Conventionally, disposing a sealed cover and a desiccating agent are used to dissolve the above-mentioned problems as mentioned in U.S. Pat. No. 5,882,761. However, the sealed cover increases the total thickness and the weigh of the OLED, and adding a desiccating agent only temporarily decreases the reacting rate of the moisture and the metal electrode. Once the desiccating agent is saturated, the desiccating agent loses its function. Moreover, complicated equipments and low-moisture environment are required to fill the desiccating agent and to apply the sealed cover so that the production cost is increased.

### SUMMARY OF THE INVENTION

It is therefore an object of the invention to provide an organic light-emitting device and a manufacturing method thereof. By using a simplified manufacturing method and thinner device to prevent metal electrode of the OLED from water moisture to be oxidized. Therefore, the display quality is improved and the life time of the OLED is increased.

The invention achieves the above-identified object by providing an organic light-emitting device including a substrate; a transparent electrode formed on the substrate; an organic emissive structure formed on the transparent electrode, a metal electrode formed on the organic emissive structure, and a first protecting layer formed on and covering the metal electrode. The first protecting layer contains an inert metal or an alloy containing an inert metal.

Also, the invention achieves the above-identified object by providing an organic light-emitting display including a substrate; a TFT device disposed on the substrate; a transparent electrode formed on the substrate; an organic emissive structure formed on the transparent electrode, a metal electrode formed on the organic emissive structure, and a first protecting layer formed on and covering the metal electrode. The first protecting layer comprises an inert metal.

Further, the invention achieves the above-identified object by providing a method of manufacturing an organic light-emitting device, comprising the steps of: providing a substrate; forming a transparent electrode on the substrate; forming an organic emissive structure on the transparent electrode; forming a metal electrode on the organic emissive structure; and forming a first protecting layer on the metal electrode. The first protecting layer comprises an inert metal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a lateral view of an organic light-emitting display according to the preferred embodiment of the invention.

FIG. 2 is a flowchart which illustrates the method of manufacturing an organic light-emitting display according to the preferred embodiment of the invention.

### DETAILED DESCRIPTION OF THE INVENTION

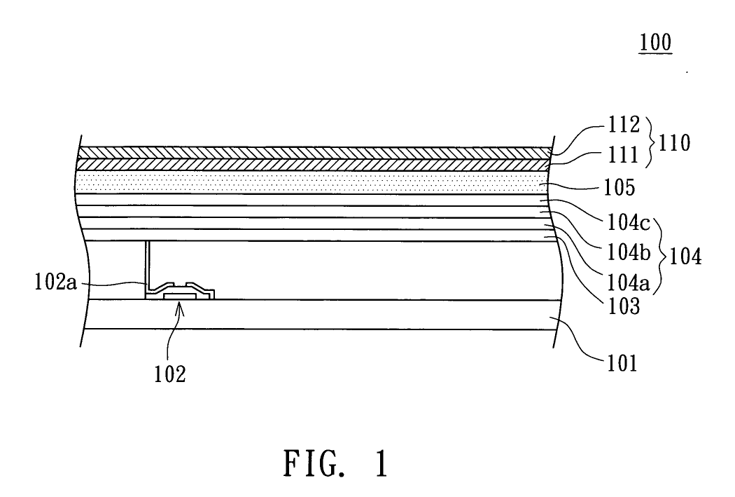

Referring to FIG. 1, it is a lateral view of an organic light-emitting display according to the preferred embodiment of the invention. The organic light-emitting display 100 includes an organic light-emitting device and a TFT device 102. The organic light-emitting device of the organic light-emitting display 100 includes a substrate 101, a transparent electrode 103, an organic emissive structure 104, a metal electrode 105, and a protector 110. The protector 110 includes a first protecting layer 111 and a second protecting layer 112 for preventing the metal electrode 105 from water moisture and oxidation. The transparent electrode 103 is formed on the substrate 101, and the organic emissive structure 104 is formed on the transparent electrode 103. The metal electrode 105 is formed on the organic emissive structure 104. The organic emissive structure 104 at least includes an electron transport layer (ETL) 104c, an emissive layer (EL) 104b, and a hole transport layer (HTL) 104a. The hole transport layer (HTL) 104a is formed on the transparent electrode 103 and is used for transporting holes from the transparent electrode 103 to the emissive layer (EL) 104b. The emissive layer (EL) is formed on the hole transport layer (HTL) 104a and is used for light emission produced as a result of recombination of holes and electrons. The electron transport layer (ETL) 104c is formed on the emissive layer (EL) 104b and is used for transporting electrons from the metal electrode 105 to the emissive layer (EL) 104b.

The first protecting layer 111 is formed on and covering the metal electrode 105, and the material of the first protecting layer 111 contains an inert metal or an alloy containing an inert metal, such as gold, silver, platinum, or an alloy of gold, silver or platinum. The first protecting layer 111 is for preventing the metal electrode 105 from water moisture and enhancing delicate extent of the metal electrode 105.

The second protecting layer 112 is formed on the first protecting layer 111, and the material of the second protecting layer 112 is a metal oxide, such as aluminum oxide, nickel oxide, indium tin oxide (ITO), silicon dioxide and silicon nitride. The second protecting layer 112 is used for preventing the metal electrode 105 from water moisture and oxidation as well.

In FIG. 1, the organic light-emitting display 100 further includes a TFT device 102 disposed between the substrate 101 and the transparent electrode 103. The source/drain 102a of TFT device 102 is electrically connected to the transparent electrode 103. The organic light-emitting device 100 is preferably an active organic light-emitting display, but the present invention in not limited thereto, and a passive organic light-emitting display is also suitable.

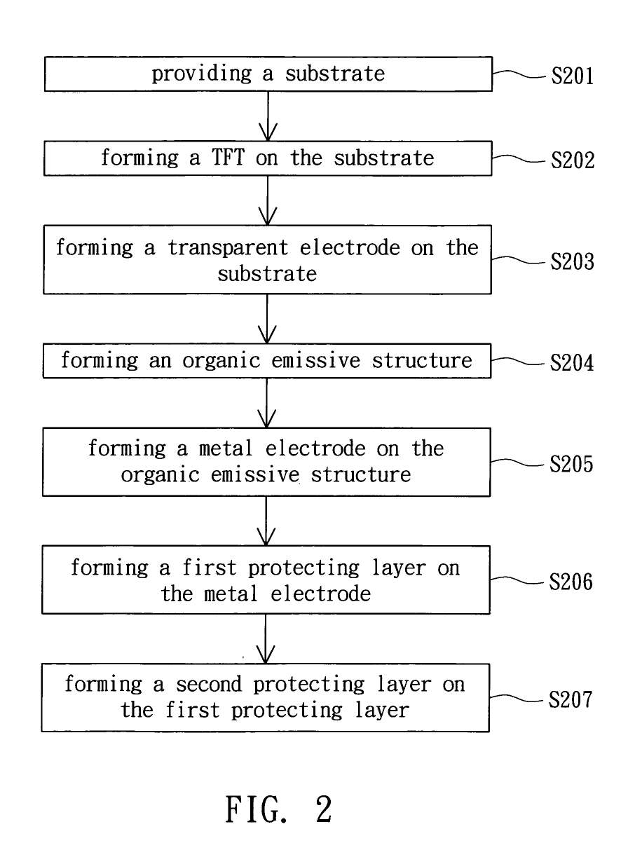

In practice, a manufacturing method of an organic light-emitting display includes the steps as below. Referring to FIG. 2, a flowchart illustrates the method of manufacturing an organic light-emitting display according to the preferred embodiment of the present invention. At first, a substrate 101 is provided as step S201 shown in FIG. 2. In the step S202, a thin film transistor (TFT) 102 is formed on the substrate 101. Next a transparent electrode 103 is formed above the substrate 101 and is electrically connected to the source/drain of TFT 102 in the step S203. Then, an organic emissive structure 104 is formed on the transparent electrode 103 as stated in the step S204. A metal electrode 105 is formed on the organic emissive structure 104 in the step S205. Further, a first protecting layer 111 is formed thereon and covering the metal electrode 105 as the step S206 shown in FIG. 2. Finally, a second protecting layer 112 is formed on the first protecting layer 111 in the step S207. The first protecting layer 111 contains an inert metal, such as gold, silver, platinum, or an alloy of gold, silver or platinum, and the second protecting layer 112 is a metal oxide, such as aluminum oxide, nickel oxide, indium tin oxide (ITO), silicon dioxide and silicon nitride. Moreover, a passivation layer (not shown in FIG. 1) is formed on the second protecting layer 112 for preventing the organic light-emitting device 100 from attrition and damage. The material of the passivation layer is preferably a polymer hard cover film or a substrate.

According to the structure of the preferred embodiment, the organic light-emitting device of the present invention can include a multi-layer metal structure as an electrode of an OLED. The multi-layer metal structure includes a first metal electrode layer formed on the organic emissive structure, a second metal electrode layer formed on the first metal electrode layer, and a third metal electrode layer formed on the second metal electrode layer. The first metal electrode layer can be as the metal electrode 105, the second metal electrode layer can be the first protecting layer 111, and the third metal electrode layer can be the second protecting layer 112. The material of the first metal electrode layer is aluminum, and the second metal electrode layer contains an inert metal, such as gold, silver, platinum, or an alloy of gold, silver or platinum. The material of the third metal electrode layer is a metal oxide, such as aluminum oxide, nickel oxide, indium tin oxide (ITO), silicon dioxide or silicon nitride.

Further, because the first protecting layer 111 and the second protecting layer 112 can protect the organic emissive structure 104 and prevent the metal electrode 105 from water moisture and oxidation, the organic light-emitting device 100 has simplified structure and the production cost is decreased. The metal electrode manufactured according to the present invention is of full protection and won't react with water moisture or other active regents so that the metal oxide layer prolongs the Q-time of the OLED device of the invention. Compared with the conventional protection method, complicated equipment and strict control of low moisture working environment are not required and the production cost is reduced.

To sum up, the organic light-emitting device disclosed in the preferred embodiment of the present invention prevents the metal electrode of the OLED from water moisture and oxidation by a simply manufacturing method and device. At first, a condensed first protecting layer is formed on the metal electrode in order to benefit electron transferring, decrease the impedance of the metal electrode, enhance working function of the metal electrode, reduce voltage of panel and improve the display quality. Also, the metal electrode with production won't react with water moisture and dark spots won't be formed. Beside, a second protecting layer does not only isolate the metal electrode from water moisture but also prevents oxidization of the metal electrode and increases the lifetime of the OLED.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An organic light-emitting device, comprising:
a substrate;
a transparent electrode formed on the substrate;
an organic emissive structure formed on the transparent electrode;
a metal electrode formed on the organic emissive structure; and
a first protecting layer formed on the metal electrode, wherein the first protecting layer comprises an inert metal.

2. The organic light-emitting device according to claim 1, wherein the inert metal is selected from the group consisting of gold, silver, platinum, and an alloy of gold, silver or platinum.

3. The organic light-emitting device according to claim 1, further comprising a second protecting layer formed on the first protecting layer.

4. The organic light-emitting device according to claim 3, wherein the material of the second protecting layer is selected from the group consisting of aluminum oxide, nickel oxide, indium tin oxide (ITO), silicon dioxide, and silicon nitride.

5. The organic light-emitting device according to claim 3, further comprising a passivation layer formed on the second protecting layer.

6. The organic light-emitting device according to claim 5, wherein the passivation layer comprises polymer.

7. The organic light-emitting device according to claim 1, wherein the organic emissive structure comprises:
a hole transport layer formed on the transparent electrode;
an emissive layer formed on the hole transport layer; and
an electron transport layer formed on the emissive layer.

8. The organic light-emitting device according to claim 1, wherein the metal electrode comprises aluminum.

9. An organic light-emitting display comprising:
a substrate;
a TFT device disposed on the substrate;
a transparent electrode formed on the substrate and electrically connected to the TFT device;
an organic emissive structure formed on the transparent electrode;
a metal electrode formed on the organic emissive structure; and
a first protecting layer, formed on the metal electrode, wherein the first protecting layer comprises an inert metal.

10. A method for manufacturing an organic light-emitting device, comprising:
providing a substrate;
forming a transparent electrode on the substrate;
forming an organic emissive structure on the transparent electrode;
forming a metal electrode on the organic emissive structure; and
forming a first protecting layer on the metal electrode, wherein the first protecting layer comprises an inert metal.

11. The method according to claim 10, further comprising forming a second protecting layer on the first protecting layer.

12. The method according to claim 11, further comprising forming a passivation layer on the second protecting layer.
